(19) United States
(12) Patent Application Publication
(10) Pub. No.: US 2006/0265326 A1
(43) Pub. Date: Nov. 23, 2006

(54) Method and apparatus for payment without payment card infrastructure

(76) Inventor: Mary Hogue Barrett, Biglerville, PA (US)

Correspondence Address: RADER FISHMAN & GRAUER PLLC, LION BUILDING, 1233 20TH STREET N.W., SUITE 501, WASHINGTON, DC, 20036, US

(21) Appl. No.: 11/132,409

(22) Filed: May 19, 2005

(51) Int. Cl. G06Q 40/00

(52) U.S. Cl. 705/40

(57) ABSTRACT

The provision of payment to a seller without requiring the seller to have traditional payment card acceptance infrastructure. Payment card information for a buyer is received in conjunction with a transaction between the buyer and a seller wherein the buyer provides the seller a given payment amount. The payment card information is preferably received through a communication by the seller with a telephone. The payment card information is then passed to a payment card processor along with information to accommodate an immediate payment to the seller. The provision of information to the payment card processor may be made despite the absence of a merchant relationship between the seller and the payment card processor. Following this, payment to the seller is accommodated upon successful processing of the payment card information by the payment card processing entity.

### BACKGROUND OF THE INVENTION

1. Field of the Invention

This invention relates generally to accommodating transactions using a payment card without requiring the seller to have merchant credit infrastructure.

2. Description of the Related Art

The usage of payment cards has become prevalent for the payment of goods or services in recent years, often replacing cash for retail transactions. Payment cards include credit cards, debit cards, and various stored value cards including smart cards and the like.

One issue with payment cards is that they require a payment card infrastructure in order to enable a transaction between a seller and a buyer. For example, with a credit card, a retail merchant (seller) often needs a point of sale terminal or related equipment configured to receive the credit card information from a buyer. Such equipment often includes a magnetic strip reader that is used to collect customer and account information from the credit card in connection with a transaction.

A merchant is also often required to establish a relationship with a credit card processor to enable payment card-based transactions. A credit card processor handles the authorization and settlement of credit card payments, and typically does so for a variety of credit cards (e.g., VISA, MasterCard, AMEX, etc.).

The need for a payment card infrastructure including equipment and established relationships impedes the ability of a seller to accept credit card payments from potential buyers. Such sellers include retail sellers that do not have the payment card infrastructure. It also includes casual sellers, such as a person having a garage sale, selling their car, or otherwise engaging in the informal sale of goods or services. Their options become limited to accepting cash or accepting personal checks or the like, along with associated risks.

Online applications have become available for transferring funds between member accounts. An example is PayPal. With PayPal, members join the service by registering and providing information including an e-mail address. PayPal relies on the existing infrastructure used by financial institutions and credit card companies. Joining PayPal and sending money through its service is typically free, but there is a fee structure in place for those members who wish to receive money. Although PayPal is useful for transactions between members, and particularly online transactions such as those initiated using eBay, it requires both parties to be members and to use the service infrastructure for the transaction. That is, the buyer and seller have accounts, and the buyer initiates the transfer to the seller's account, such as through the e-mail address associated with the account. Accordingly, PayPal is useful but still fails to address the above-described needs in the offline environment.

Other systems that implement the credit card payment system have been developed. One such system leverages the credit card system in reverse to accommodate the submission of cash payments at numerous merchant locations. Cash payments are submitted by an end user to one merchant at a point of sale. The end user has an account that is then credited according to the cash payment electronically. The end user may then use the account balance in transactions with a vendor, with payments being made not using the credit card but rather through the account balance. These systems are also useful for certain applications, but again do not solve the above-described offline transaction problems. They require infrastructure, such as a merchant that takes the cash payment and accommodates the population of the account thereafter. They also require the vendor to have whatever infrastructure is required to receive payment through the end user account.

Other systems provide an online account whose balance may be credited based upon a transaction with a buyer, using the buyer's credit card information. An example of such a system is provided by ProPay. Typically, a user registers on the system to create the online account. This may involve navigating to the appropriate website, selecting the desired type of account, filling in registration information including name, address and e-mail contact information, mailing an annual membership fee to the service provider, receiving an account activation e-mail, and then logging into the system using the provided e-mail address and a password to access the account. The user may then accept a credit card from a buyer or the like, by logging into the system as noted, filling in fields regarding the credit card information and the amount to be charged, and submitting the charge. After one or more days, the charged amount may become available in the user's online account. The user may also then transfer funds to other accounts including checking accounts, which typically also takes one or more days.

While these online account systems are useful to certain merchants who want to accept credit cards but do not want to invest in traditional credit infrastructure, they remain difficult to use in many typical situations, including the above-described informal sales made by individuals. One reason for this is that the online accounts require a formal registration, submission of an annual fee, and other steps prior to account activation, which may take quite a while. The registration burden and time lag render these systems too cumbersome to use in certain environments. Furthermore, the online provision of services requires the user to own or otherwise access costly computer equipment and online access.

Thus, what is needed is a payment card acceptance system that eases the ability for a user to accept payment cards and does so without requiring undue investment in credit infrastructure and corresponding relationships.

### SUMMARY OF THE INVENTION

The present invention accommodates the provision of payment to a seller without requiring the seller to have traditional payment card acceptance infrastructure.

In one embodiment, this entails receiving from a seller a payment card information for a buyer in conjunction with a transaction between the buyer and a seller wherein the buyer provides the seller a given payment amount for at least one of a good or a service (including the provision of currency to the “buyer”).

Preferably, the payment card information is received through a communication by the seller with a telephone. This allows the payment provision services to be provided to anyone having a traditional telephone, and thus avoids the need for special equipment.

The payment card information is then passed to a payment card processor along with information to accommodate an immediate payment to the seller. The provision of information to the payment card processor may be made despite the absence of a merchant relationship between the seller and the payment card processor.

Following the passage of information as such, payment to the seller is accommodated upon successful processing of the payment card information by the payment card processing entity. Ultimate settlement then may proceed in the traditional fashion, which may vary depending upon the type of payment card being used. Where the payment card is a credit card, the buyer may ultimately be sent a bill for the noted amount against his credit card account.

The provision of payment to the service provider may be variously accommodated. In one embodiment there may be cash payment to the seller of given amount less a fee for accommodating the immediate payment, where the fee is designated to the service provider. In another embodiment there may be cash payment of the full given amount to the seller, with the seller and service provider engaging in some fashion to accommodate payment of the service provider fee.

The present invention can be embodied in various forms, including business processes, computer-implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIGS. 1A-B are schematic diagrams illustrating a process for providing immediate payment pursuant to a payment card-based transaction in accordance with the present invention.

FIG. 2 is a block diagram illustrating an immediate payment system in accordance with the present invention.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

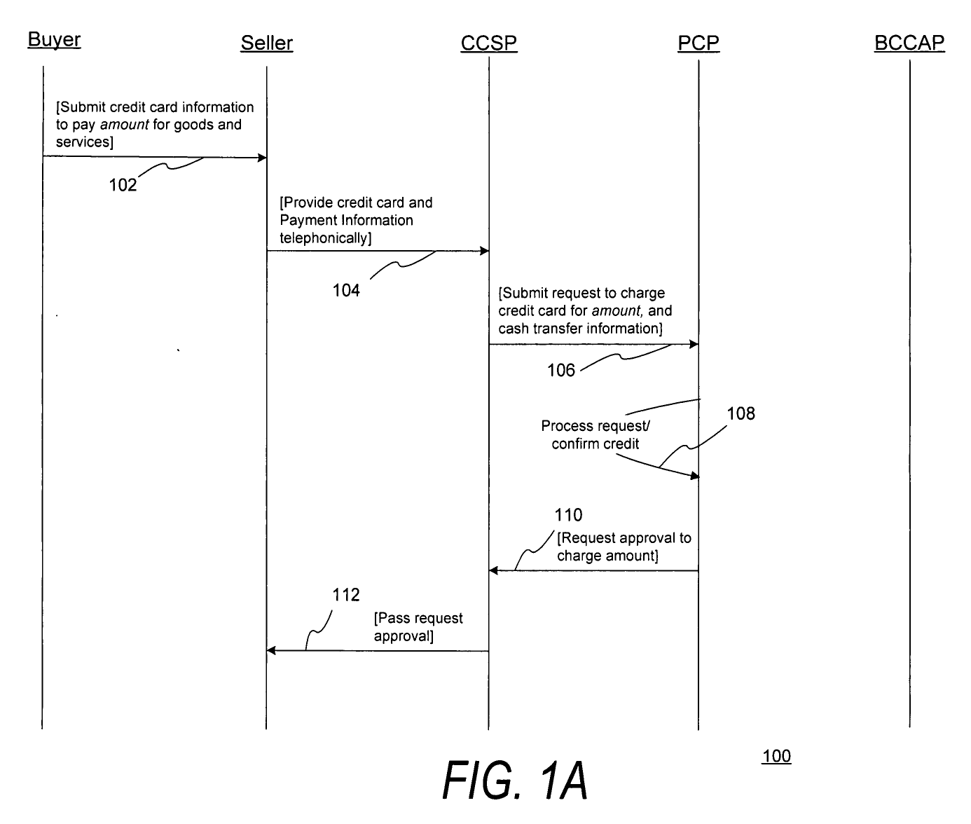

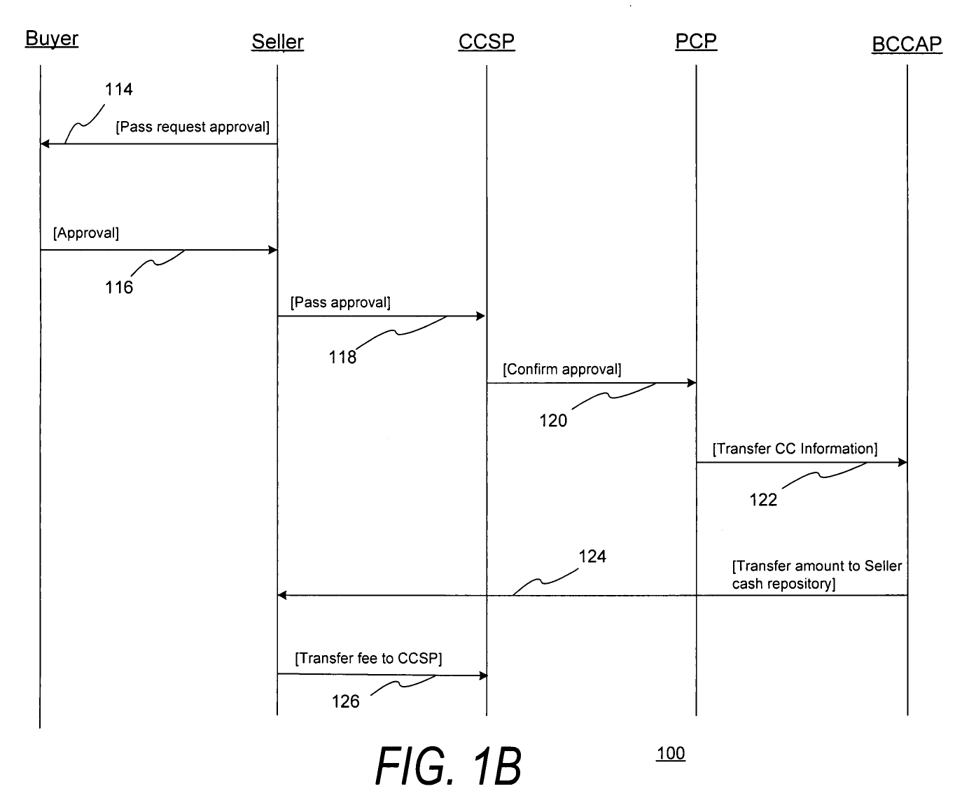

FIGS. 1A-B are schematic diagrams illustrating a process 100 for providing immediate payment pursuant to a payment card-based transaction in accordance with the present invention. The illustrated participants include a Buyer, Seller, Cash for Credit Service Provider (CCSP), Payment Card Processor (PCP), and Buyer's Credit Card Account Provider (BCCAP).

The Seller may be a casual seller such as a person selling an item at a garage sale, a car through a classified advertisement, a service, or the like. The Seller may also be a formal merchant, but most likely one that has not obtained the infrastructure and entered into formal relationships for receiving payments by payment cards.

The Seller also has a cash repository. The cash repository is preferably an account from which a cash withdrawal may be made, such as an account at a bank or savings and loan. An example of such an account is a checking account.

The Buyer is a person intending to purchase goods or services from the Seller. The Buyer has some form of payment card for making the purchase. Examples of payment cards may include credit cards, debit cards, smart cards, stored value cards, and the like.

The CCSP interfaces with the Seller to receive information about a transaction between the Buyer and Seller and to effect immediate payment to the Seller's cash repository pursuant to a completion of that transaction. The CCSP accommodates the provision of payment to the Seller without requiring the Seller to have payment card infrastructure by receiving from the Seller payment card information for the Buyer in conjunction with the transaction between the Buyer and the Seller, where the payment card information is received through a telephonic communication using a device that is devoid of a dedicated infrastructure (e.g., a magnetic strip reader) for receiving and sending payment card information.

As described in the background section, merchants typically need to have infrastructure plus a relationship with a credit card processing entity in order to accept credit cards from buyers. Similar scenarios are required for other types of payment cards. Here, the relationship with the PCP is previously established by the CCSP, and the CCSP receives relevant payment card information through a simple telephonic communication. Accordingly, the need for both formal credit-processing relationships and processing infrastructure are eliminated for sellers wishing to accept payment cards.

The PCP is preferably a conventional processor such as a credit card processor, with which the CCSP has an established relationship. The PCP authorizes and then (typically through another entity, i.e., the BCCAP, although the PCP and BCCAP may be one and the same) settles payment card payments, typically handling several types of credit and other payment cards. Ordinarily, merchants retain payment card processors for those payment cards that the merchant wishes to accept. A merchant ID is issued in connection with the established relationship. Here, the CCSP retains the PCP and thus provides the relevant information and interfaces with the PCP using an appropriate identifier. The PCP may also broker the participation of other parties such as credit bureaus and banks as needed to complete a transaction. This is preferred because no banking relationship is created.

Referring to FIG. 1A, the process of completing a transaction and receiving payment is described. For ease of discussion a credit card embodiment is discussed, although the present invention is applicable to other types of payment cards as described elsewhere.

Pursuant to intending to transact for the purchases of goods or services, the Buyer submits 102 credit card information to the Seller. This transaction can widely vary, and may comprise various goods and/or services including provision of cash. For example, the Buyer may wish to buy a set of golf clubs from the Seller for an amount, say $100.00. Following the establishment of the basis for the transaction, the credit card information is then provided to the Seller. This may be a verbal indication of the information from the Buyer.

According to one aspect, the PCP may agree to process payment cards based upon information received from the CCSP provided that the CCSP assumes the fraud risk. Under such conditions, the CCSP may desire verification of Buyer possession of the payment card by the Seller, and possibly other safeguards such as checking an identification to see whether it matches the information on the payment card.

Preferably, the payment (e.g., credit) card information and payment information is then provided 104 by the Seller to the CCSP. As distinguished from online account providers and the like, which require a previous arrangement of an account and steps such as payment of a check for an annual fee, the CCSP preferably accommodates provision of the immediate payment service in the first instance of usage of the service, and does so telephonically. Thus, a Seller who has not previously established a relationship with the CCSP may simply dial a telephone number, enter the credit and payment information, and then automatically receive payment.

The script for accommodating the receipt of this information may vary as desired, and may invoke voice recognition and/or telephone keypad entry of the information as desired. Of course, although payment without a previously established relationship is supported according to this aspect of the present invention, there may be a form of registration that allows the Seller to avoid re-entry of duplicative information each time the service is invoked as well.

The script may be variously provided depending upon the type of payment card, related requirements, and the design preferences of the service provider. One example of a script includes identification, legality and performance components. The identification component accommodates an identification of the Seller. This may be established via entry of a password for previously established users. The identification portion of the script also accommodates receipt of credit information and related information about the Buyer. The Seller may be prompted to confirm that the Buyer has shown the Seller both the credit card and a qualifying piece of identification that confirms that the Buyer matches the credit card. The Seller may also be prompted to confirm that Seller takes responsibility that this Buyer is the person whose credit card is being used. Security may be addressed as desired, with corresponding configuration of the script.

The legality component of the script seeks confirmation from the Seller that the underlying transaction is a legal transaction. The performance component seeks confirmation that the Seller takes responsibility to perform for the underlying transaction, whether it is the provision of goods or services, including the provision of cash to the Buyer.

The script continues by requesting indication(s) of what the underlying transaction is for (i.e., (1) “goods” or “services”; (2) optional further identification in more detail; and (3) the corresponding amount).

Finally, the script may include tax subroutine and service provider charges sections. Given the amount, the identification of the object of the transaction, and potentially other information such as the location of the Buyer and/or Seller, the tax subroutine accommodates a calculation of the sales tax for the transaction. The sales tax is then included in the amount (i.e., the “amount” is increased to include both the transaction amount plus the sales tax). If desired and allowable, the tax subroutine may merely record and notify that Seller or Buyer is liable for collecting and paying the sales tax separately, in which case the sales tax is not included in the amount.

Accordingly, the present invention may actually provide a higher level of security than traditional signature-based systems.

The service provider charges are based upon what the CCSP charges the Seller for the service. This may, for example, be a flat fee or a percentage of the transaction amount. The service provider's charges are also included in the amount where applicable.

Still referring to FIG. 1A, the credit card information preferably includes the credit card number, name of person listed on the credit card, and the expiration date. The payment information may include the amount of the transaction (e.g., $100.00, plus tax and/or CCSP fee if applicable) and an automatic clearing house (ACH) number corresponding to the Seller's cash repository. The information may be retained in a database for subsequent usage if desired. Additional information may or may not be required based upon the type of payment card being used and corresponding requirements and practices. This information may include address information, usage control numbers, etc. It may also include information that allows the CCSP to reward users for referrals. For example, a CCSP may provide a discount to a Seller who refers five new sellers to the system. The Seller's registration identification may be used to identify him as the referring party. Preferably, none of the Buyer's information would be retained to confer greater security to the Buyer against future fraud.

Although one useful feature of the present invention is the ability to provide the comprehensive CCSP service through a simple conventional telephone, it is possible for the credit card information to also be collected through automated means, particularly as inclusion of such interfaces on conventional consumer market telephones becomes more prevalent.

Once this information is collected through the telephonic connection, the CCSP compiles the information and submits 106 to the PCP a request to charge the credit card for the amount indicated, along with any other appropriate information to initiate the processing of the payment card and payment to the Seller. The initial processing 108 of the request by the PCP entails an identification of the credit account corresponding to the credit card and a confirmation that a charge in the amount indicated is allowable (e.g., given the credit limit and the consumed balance versus the amount intended to be charged). The CCSP has previously established itself as a merchant capable of accepting credit cards, so the CCSP will have a merchant ID and infrastructure for communicating the credit and payment information to the PCP.

Following the initial processing 108, a request 110 for approval to charge the noted amount is sent to the CCSP, for passage 112 to the Seller and then 114 the Buyer, as illustrated in FIG. 1B. Specifically, the initial request 110 may be provided according to conventional credit processing techniques. Then, the CCSP accommodates the preparation and transmission of a telephonic message indicating the request (112) for approval confirmation (116) to charge the noted amount. The request from the CCSP (112) may be in the form of an audio message with a prompt to hit a keypad number for confirmation to charge the credit card. The prompt may request that such confirmation (116) be made by or on behalf of the Buyer.

Still referring to FIG. 1B, once approval is indicated 116 to the Seller and passed 118 to the CCSP it is confirmed 120 to the PCP. The PCP then accommodates transfer of cash to the Seller by passing 122 the credit card information to the BCCAP, whereupon the BCCAP transfers 124 payment to the Seller's cash repository. This may be variously embodied depending upon the type of payment card and desires of the parties. In one embodiment, the ACH for a Seller account is provided in conjunction with the credit request. This information may be initially provided by the Seller to the CCSP in arranging the credit request. The information may also be retained in association with the particular Seller for subsequent usage of the CCSP service by the Seller. Using the ACH the BCCAP transfers 124 cash in the amount to the Seller's cash repository.

There are various ways for the CCSP to collect 126 a fee for providing the service. The amount of the fee can be notified to the Seller in the telephonic communication between the Seller and the CCSP. Although it may vary, for ease of description, assume that it is 3.5% of the transacted amount. Thus, for the $100.00 transaction the fee will be $3.50. Basically, the desired result will be $100.00 charged to the Buyer's credit card, whose BCCAP then transfers by ACH a $96.50 payment to the Seller, and a $3.50 fee payment to the CCSP. One way of accommodating this is having the total ACH payment ($100) to the cash repository of the Seller, followed by a payment of the fee by the Seller to the CCSP by any agreed upon means. Another way of accommodating this is providing two ACH numbers to the PCP and two corresponding amounts to be charged to the BCCAP. This would result in a transfer of the transaction amount less the fee to the cash repository of the Seller, and the transfer of the fee amount to the cash repository of the CCSP. The ordinarily skilled artisan will recognize the various alternatives for effecting the appropriate payments to and among the parties. Payment may be received in accounts other than checking or savings accounts. For example, Seller's credit card account balance may be reduced where his credit account is designated as the target of the payment.

Following the above-described transaction, the Buyer will be issued a bill in connection with the credit card account in the usual fashion. The Buyer is liable for the debt(s) he instructed the BCCAP to absorb on his behalf when he gave the credit card information to the Seller, after transaction approval is received by the Seller from the BCCAP and is processed accordingly.

Settlement is preferably per-transaction but transactions may be accumulated and settled in batch if desired. The CCSP designer may also elect to break down transactions if such is desired. The CCSP may rely upon statutory liability limits (e.g., $50.00 for credit card transactions). The CCSP may also impose higher fees for certain transactions, such as higher fees for rent payments as opposed to propane payments. Also, the CCSP may impose a transaction amount limitation. This may result in multiple fees, one for each transaction, when the transaction amount exceeds the limitation. For example, with a transaction amount limitation of $1000, a seller may still use the CCSP to sell a car for $5000, but may need to break payment down into five separate $1000 transactions. Because credit card approval would be required for each separate transaction, the potential exposure to fraud is reduced.

It should be noted that the present invention may be variously embodied and is not limited to the “garage sale” scenario. In particular, the process may be used in a situation where a credit card holder is seeking to receive cash in connection with usage of the CCSP service. There are numerous applications for the CCSP service including but not limited to: a) an individual seller could accept a payment card for only one transaction or many; b) Seller could be a start-up business with an initial low number of customers to charge, who benefits from the Pay-As-You-Go method until the volume reaches a critical mass, such that speed becomes more important than convenience (there are many situations were someone would rather pay a little more per transaction, rather than paying a larger sum (upfront)); c) single event for an entity who conducts few commercial activities per year (fundraisers, charities, auctions, raffles, bingo), school or civic entity events requiring ticket sales (in advance or at gate); d) any activity where advertising style targets consumers willing to send a check with a SASE for receipt of something; e) the roving or remote seller/servicer who works out of home office or vehicle (part-time accountant, housekeeper, handyman, crafter, farrier, cab driver, etc.); f) payment of rent or earnest money or deposit for vacation lodging offered by landlords or real estate broker/agents who do not conduct volume real estate business; or any other scenario where a payment card holder wants to make use of the card by interfacing with an entity differing from a traditional merchant having payment card receiving infrastructure.

In addition to the above-described conveniences over traditional payment systems, the present invention provides the added benefit of empowering people to engage in more transactions. Referring to the payment of rent scenario described above, the landlord and the tenant may use the CCSP to accommodate the payment of rent. This is beneficial to the landlord, in that the landlord will receive a much greater assurance of receiving rent payment than the landlord would if he waited for cash or relied upon a check (which may bounce or may even be fraudulent). And, of course, it is beneficial to the tenant in that it provides a convenient way of paying rent when he is short of cash.

Another advantage of the present invention is that it easily accommodates a “pooled resources” scenario where associated individuals seek to commonly pay for a given transaction. A good example of this may be a medical bill that a patient receives. The patient's family and friends may respectively use their (e.g., credit) cards to separately contribute amounts that may cumulatively cover the entire medical bill. This is beneficial to the patient in that the bill is reconciled, and provides a convenient way for others to contribute to the payment of the bill.

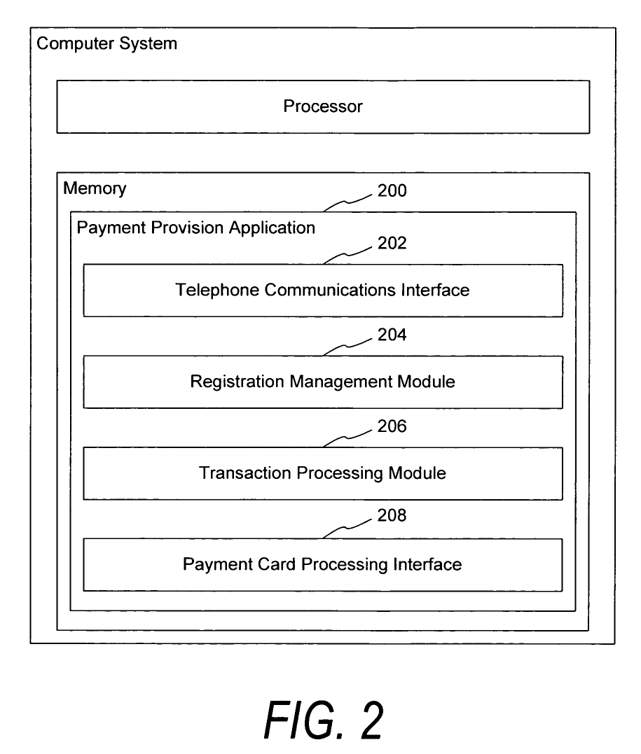

FIG. 2 is a block diagram illustrating a payment provision application 200 in accordance with the present invention. The payment provision application 200 is preferably implemented by the previously-described CCSP and resides in a computer system that includes a processor and memory that stores the instructions for carrying out the payment provision process.

The payment provision application 200 is preferably provided as software but may alternatively be provided as hardware or firmware, or a combination of software, hardware and firmware. Although one modular breakdown of the components of the payment provision application 200 is shown, it should be understood that the functionality may similarly be provided using greater, fewer or differently named modules, or may implement any type of software architecture, modular or otherwise.

The payment provision application 200 includes a telephone communications interface 202, a registration management module 204, a transaction processing module 206, and a payment card processor interface (PCPI) module 208.

The telephone communications interface 202 accommodates communicating with users over the telephone. As described, payment card information and payment information (e.g., payment amount, ACH) is received telephonically such as through voice commands or keypad entry of information. Conventional computer telephony systems and software may be used to accommodate the interface with users and the corresponding collection of information. An initial function may accommodate recognition where a previously registered user is initiating contact, and queuing of the script for interfacing with a user in the first instance where the caller is not recognized as a previously registered user. An example of a script is described in detail above, although the script may vary depending upon legal requirements, custom and the desires of the service provider.

The registration management module 204 accommodates the maintenance of information related to registered users, which may include name, address, telephone number, and other information for the registered user. Registration is optional. Automatic payment based upon payment card information may be provided without a formal registration, but users may opt for registration so that subsequent calls requesting service are automatically recognized, and so that some information does not need to be re-entered for each transaction. Conventional database and database management techniques may be used to organize the registration management module 204 and its corresponding functionality.

The transaction processing module 206 receives information about a transaction and organizes it as a set of information that can be accessed pursuant to a payment card processing request. Preferably, a transaction identifier is associated with a particular transaction. A user (seller) identifier, transaction amount, credit card information, and payment (e.g., ACH account) information may be stored in association with the transaction identifier. In addition to this information, a field that indicates the status of the payment may be retained. For embodiments where payment of the fee portion is to be provided by the user to the service provider, indicia of receipt of the fee may also be provided.

The PCPI module 208 is in operative communication with the transaction processing module 206 and thus receives the payment card information and account payment information in order to pass along a processing request to a payment card processor. The PCPI module 208 also is configured to communicate with the PCP. Preferably, an encrypted communication containing the credit card information and transaction amount are provided.

Following a settlement of the transaction, as described above the credit card bill is ultimately sent to the Buyer in the usual fashion, detailing the charges against the credit card account. The charges will likely identify the CCSP but the CCSP may construct the charge so that information of the Seller also appears, which may be more helpful in assisting the Buyer's recollection of the transaction.

Accordingly, the present invention improves upon several existing methods of conveyance so that more financial transactions can occur faster, easier, cheaper, safer, to and from a much broader range of citizenry, accessible from a broader range of locations than typical commercial locations. Thus, people and organizations are empowered to do more business. Moreover, in addition to the cost benefit of obviating the need for traditional, expensive infrastructure typically based upon annual contracts for rental equipment and swipe machine equipment to engage in payment card transactions, the present invention reaches an audience that need only be capable of operating a traditional telephone. This opens commerce and related opportunities to segments of the population that traditionally have been shut out of market participation, whether through lack of start-up funding, education or experience.

Thus, embodiments of the present invention produce and provide automatic payment for payment cards. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for accommodating the provision of payment to a seller without requiring the seller to have payment infrastructure, the method comprising:
receiving from a seller a payment card information for a buyer in conjunction with a transaction between the buyer and a seller wherein the buyer provides the seller a given payment amount for at least one of a good or a service, the payment card information being received through a communication by the seller with a telephone;
passing the payment card information to a payment card processor along with an information to accommodate an immediate payment to the seller without requiring the seller to have a merchant relationship with the payment card processor; and
accommodating the immediate payment to the seller upon successful processing of the payment card information by the payment card processing entity.

2. The method of claim 1, wherein the immediate payment to the seller is the given amount of cash less a fee for accommodating the immediate payment.

3. The method of claim 1, wherein the information to accommodate payment to the seller includes an automatic clearing house number corresponding to an account of the seller.

4. The method of claim 2, wherein accommodating the immediate payment to the seller comprises immediately transferring funds into an account of the seller using a first automatic clearing house number.

5. The method of claim 4, further comprising:
receiving funds for the fee for accommodating the immediate payment via a second automatic clearing house number.

6. The method of claim 1, wherein the payment card information originates from a credit card of the buyer.

7. The method of claim 1, wherein the payment card information originates from a debit card of the buyer.

8. The method of claim 1, wherein the communication by the seller includes an entry of a number for the payment card information using a keypad of the telephone.

9. The method of claim 1, wherein the telephone is devoid of a dedicated infrastructure for receiving payment card information.

10. The method of claim 9, wherein the dedicated infrastructure includes a magnetic strip reader.

11. An apparatus for accommodating the provision of payment to a seller without requiring the seller to have payment infrastructure, the apparatus comprising:
means for receiving from a seller a payment card information for a buyer in conjunction with a transaction between the buyer and a seller wherein the buyer provides the seller a given payment amount for at least one of a good or a service, the payment card information being received through a communication by the seller with a telephone;
means for passing the payment card information to a payment card processor along with an information to accommodate an immediate payment to the seller without requiring the seller to have a merchant relationship with the payment card processor; and
means for accommodating the immediate payment to the seller upon successful processing of the payment card information by the payment card processing entity.

12. The apparatus of claim 11, wherein the immediate payment to the seller is the given amount of cash less a fee for accommodating the immediate payment.

13. The apparatus of claim 12, wherein accommodating the immediate payment to the seller comprises immediately transferring funds into an account of the seller using a first automatic clearing house number.

14. The apparatus of claim 13, further comprising:
means for receiving funds for the fee for accommodating the immediate payment via a second automatic clearing house number.

15. The apparatus of claim 11, wherein the payment card information originates from a credit card of the buyer.

16. The apparatus of claim 11, wherein the communication by the seller includes an entry of a number for the payment card information using a keypad of the telephone, wherein the telephone is devoid of a dedicated infrastructure for receiving payment card information.

17. A system for accommodating the provision of payment to a seller without requiring the seller to have payment infrastructure, the system comprising:
a transaction processing module, which receives from a seller a payment card information for a buyer in conjunction with a transaction between the buyer and a seller wherein the buyer provides the seller a given payment amount for at least one of a good or a service, the payment card information being received through a communication by the seller with a telephone; and
a payment card processing interface module, in communication with the transaction processing module, which passes the payment card information to a payment card processor along with an information to accommodate an immediate payment to the seller without requiring the seller to have a merchant relationship with the payment card processor, pursuant to accommodating the immediate payment to the seller upon successful processing of the payment card information by the payment card processing entity.

18. The system of claim 17, wherein accommodating the immediate payment to the seller comprises immediately transferring funds into an account of the seller using a first automatic clearing house number.

19. The system of claim 17, wherein the payment card information originates from a credit card of the buyer.

20. The system of claim 17, wherein the communication by the seller includes an entry of a number for the payment card information using a keypad of the telephone, wherein the telephone is devoid of a dedicated infrastructure for receiving payment card information.
